(19) United States
(12) Patent Application Publication
(10) Pub. No.: US 2009/0319929 A1
(43) Pub. Date: Dec. 24, 2009

(54) INTERFACE FOR MULTIPLE USER SPACES

(75) Inventors: Xinlei Wang, Shanghai (CN); Melora Zaner-Godsey, Shanghai (CN); Cici Fan, Shenzhen (CN); Lucia Chen, Shanghai (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,816

(22) Filed: Jun. 22, 2008

(51) Int. Cl. G06F 3/048

(52) U.S. Cl. 715/765

(57) ABSTRACT

A display for multiple user spaces and corresponding activity levels is disclosed. For example, one embodiment comprises displaying a first user space including a first status representation in a user interface, displaying a second user space including a second status representation in the user interface, and changing the first status representation or the second status representation based on a change in status for the first user space or the second user space.

### BACKGROUND

The development of computing networks such as the Internet has fostered communication based applications including email, internet messaging, web camera communications, social networking, etc. While some of these applications provide a place for users to communicate or a place for a user to establish a web presence, these applications remain isolated from each other with a limited dynamic sense of place, time or user reputation. Further, tools provided by these applications do not inspire exploration or play, nor do they reward or encourage users for efforts to develop an online presence, identity, reputation, etc.

### SUMMARY

Accordingly, various embodiments to display multiple user spaces and corresponding status levels are described below in the Detailed Description. For example, one embodiment comprises displaying multiple user spaces within a location or themed place where users can determine indications of status or reputation at a glance based upon placement, location, highlights, detail, etc.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of an embodiment of a system for providing an interface for multiple user spaces according to the principles of this disclosure.

FIG. 2 shows a process flow depicting an embodiment of a method for an interface to show multiple user spaces according to the principles of this disclosure.

FIG. 3 shows an example interface showing a flower themed place for multiple user spaces.

FIG. 4 shows the example interface showing a flower themed place from FIG. 3 with a mouse hover over of a flower with an update.

FIG. 5 shows an example interface showing a virtual earth themed place for multiple user spaces.

FIG. 6 shows the example interface showing a virtual earth themed place for multiple user spaces that is filtered based upon features specific to a portion of the user spaces.

FIG. 7 shows the example interface in FIG. 5 including a menu with customization tools.

### DETAILED DESCRIPTION

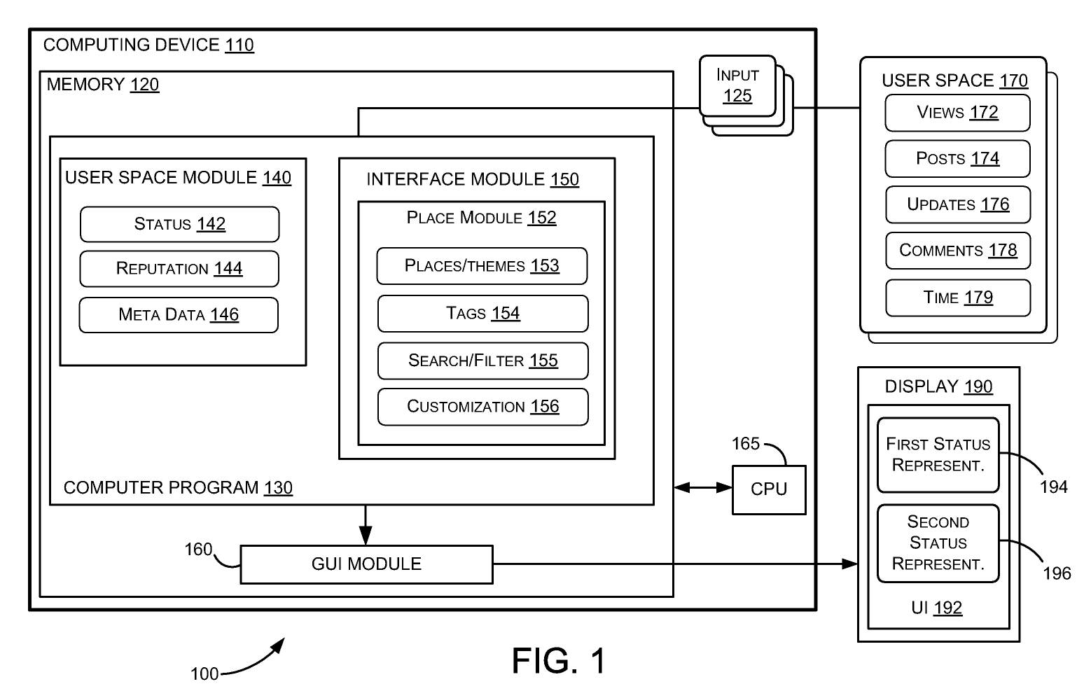

FIG. 1 shows an example system 100 for displaying multiple user spaces and corresponding status levels within a location or themed place in a user interface 192 allowing users to determine indications of status or reputation at a glance based upon placement, location, highlights, detail, etc., of the user spaces. Further, status or reputation may dynamically change based upon activity of a user space. Although embodiments related to spaces are described herein, the principles within this disclosure may be applied in any suitable social network or in an online content publishing system. For example, in a social network embodiment, a service or a client may be substituted for a space, wherein the service or the client may comprise modules such as user profiles that may exist for a computing device such as a personal computer, a mobile device, a gaming console, etc. These and other aspects of the appended claims are described in various embodiments in more detail in the following detailed description.

System 100 includes a computing device 110 with an input, a memory 120, a computer program 130, and a processor 165 in communication with the input and the memory 120. System 100 includes a user space module 140 configured to receive an input 125 related to a first user space 170 and to update a status of the first user space 170, and an interface module 150 configured to generate a first status representation 194 related to the first user space 170 and a second status representation 196 related to a second user space. The status representations or other displays related to a user space, a place for multiple user spaces, etc. may then be sent to a GUI module 160 and prepared for display in user interface 192, for example in display 190.

It will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, personal computers, gaming devices, servers, laptop computers, hand-held devices, cellular phones, microprocessor-based programmable consumer electronics and/or appliances, routers, gateways, hubs and other computer networking devices.

Referring to FIG. 1, user interface 192 may be configured to display the first and the second status representations, and change the first status representation 194 based on the input 125 related to the first user space 170 when the status for the first user space 170 is updated. In some embodiments, a change in status may be a change in reputation. For example, the change in reputation may further include a representation of at least one of how many views 172 a user space receives from other users, how often a user space receives updates 176 or posts 174, how many comments 178 a user space receives, how much time 179 a user space has existed, as non-limiting examples. In this way, an active user space may provide an indication of a high reputation among a plurality of user spaces. Other embodiments are not so limited, for example, other users, social networks, etc. may affirmatively rank the reputation or status of a user space and this reputation or status may in turn be represented in the user space, in a themed space or location showing multiple user spaces, etc.

In some embodiments, user space module 140 may receive an input 125 related to a first user space 170 and may determine a status 142, a reputation 144, etc. of a first user space 170 and forward the status 142 or reputation 144 to interface module 150. Additionally, user space module 140 may compile or process other meta data 146 related to one or more user spaces to provide a rich user experience by connecting or relating spaces, filtering spaces, etc.

Interface module 150 may include a place module 152 to generate a place for multiple user spaces or for status representations of multiple user spaces. For example, place module may generate places or themes 153, tags 154 to identify certain characteristics of a user space, search or filtering functionality 155 to search user spaces based on tags 154 or other meta data 146, or customization tools 156 to allow a user to change an interface style, add items representing a belief or action of a user, add functionality or otherwise change a user space, blog, status representation. For example, customization tools 156, edits, adding items, etc., may be provided as a drop down menu in user interface. Other embodiments are not so limited and interface module may include additional functionality to generate places or prepare user spaces for display according to user selected or added functionality, themes, privacy settings, etc.

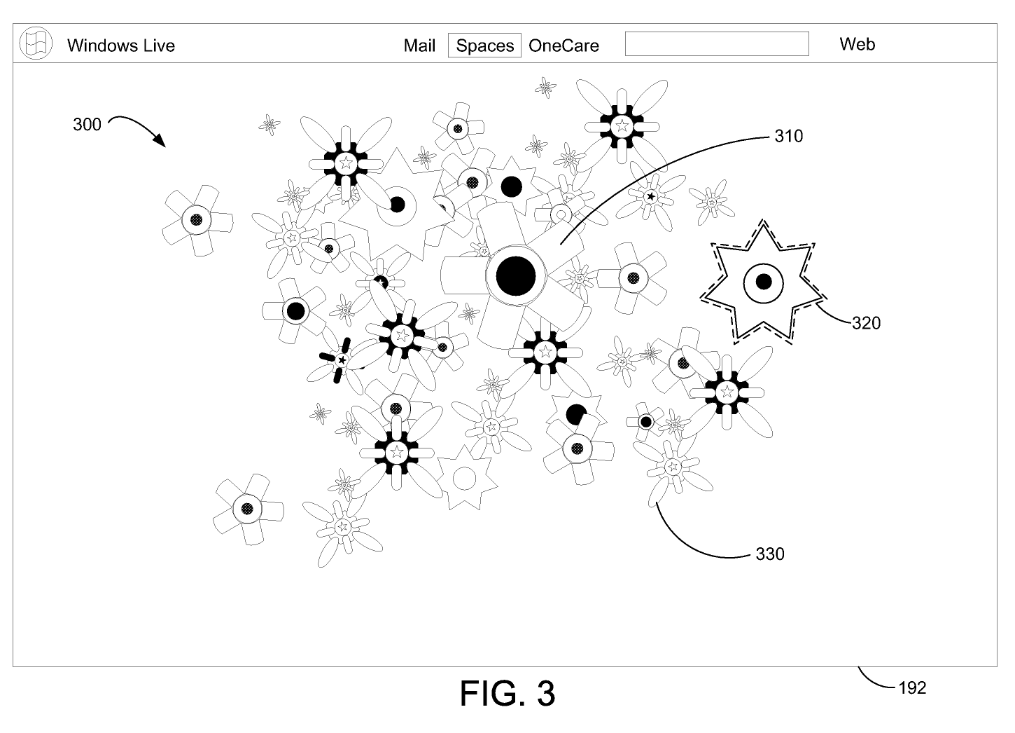

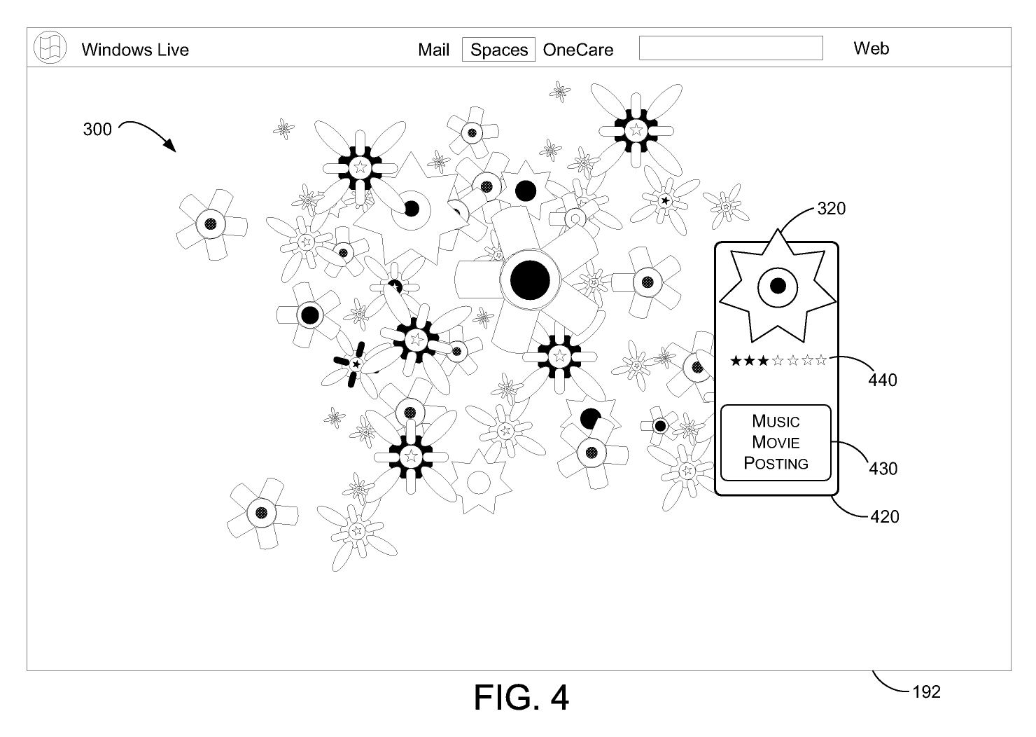

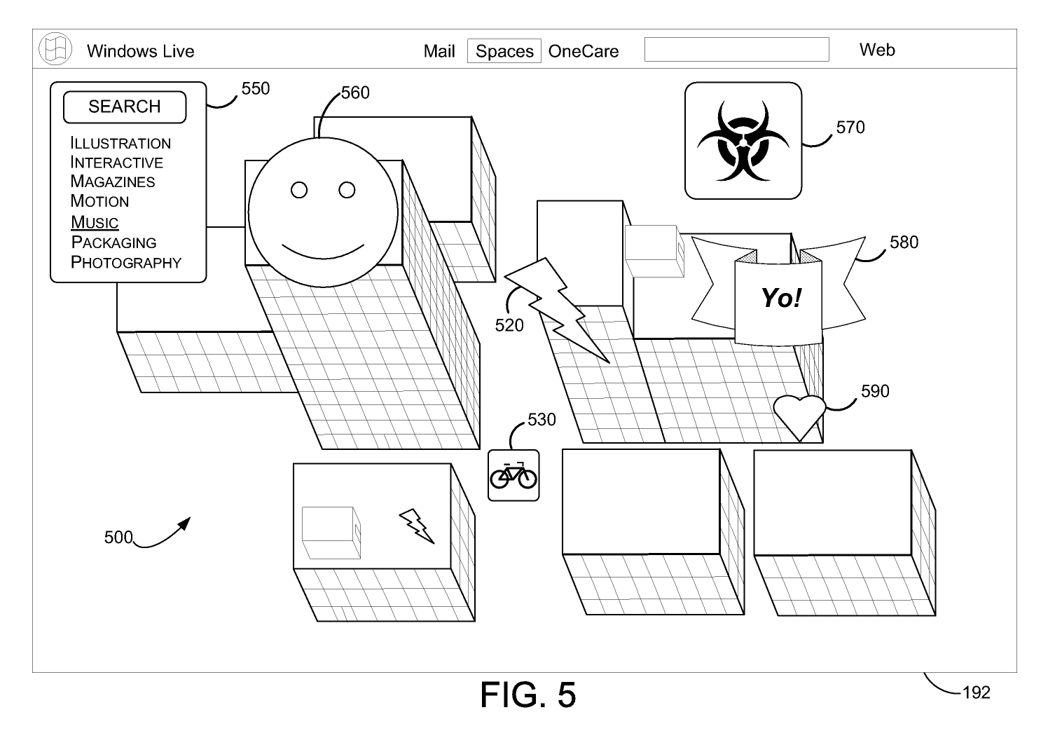

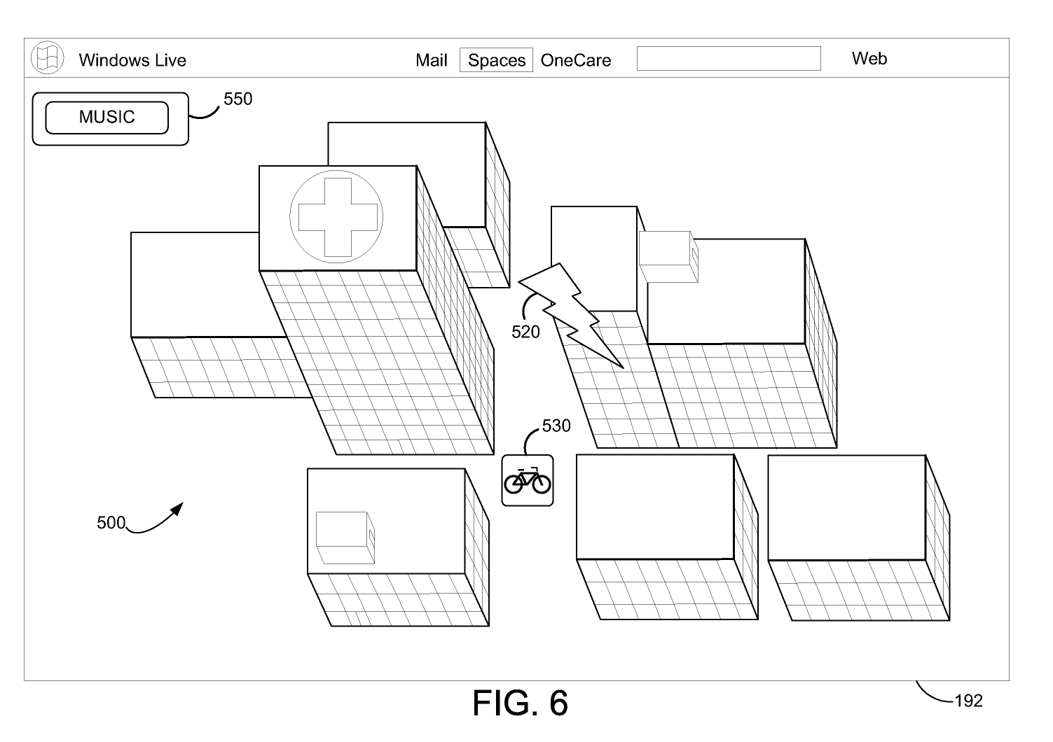

In some embodiments, each user may choose to represent user spaces within a place such as a virtual location or themed place of their choice, and each of these places may be set by each respective user. In this way, a place may be customizable but may still dynamically represent activity, status, reputation, etc. of different user spaces accordingly. As non-limiting examples, FIGS. 3-4 illustrate a themed place with a flower theme and FIGS. 5-6 illustrated a graphical representation of a picture of a city that may be used as a place to display icons or graphics representing user spaces, status representations, etc., as described below in more detail.

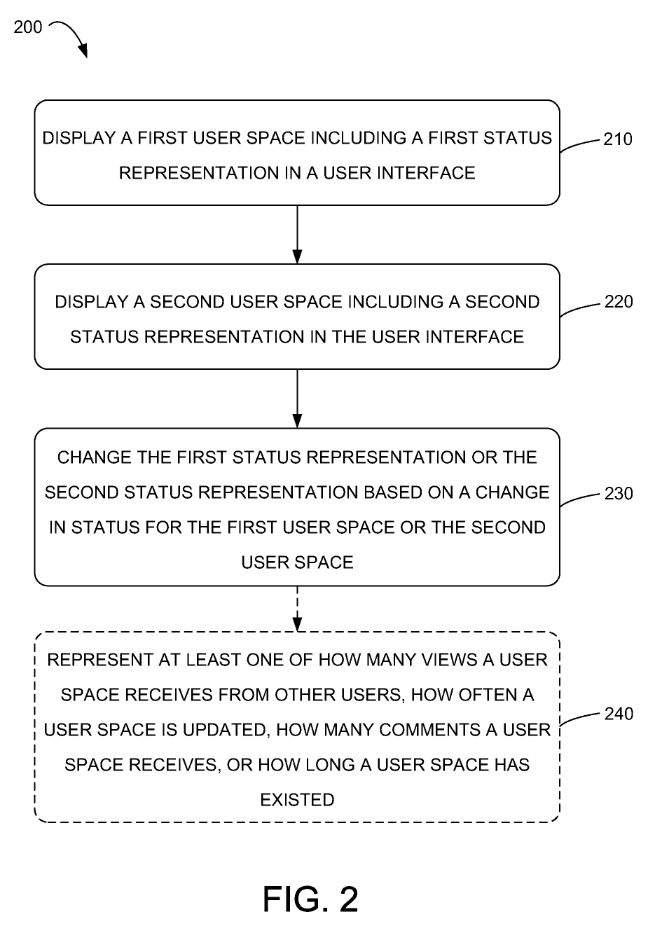

FIG. 2 shows a process flow depicting an embodiment of a method 200 for displaying multiple user spaces and corresponding status levels in a user interface. First, as indicated in block 210, method 200 comprises displaying a first user space including a first status representation in a user interface. For example, method 200 may further comprise displaying an update to the first user space or the second user space, wherein displaying an update includes highlighting the first user space or the second user space within the user interface. In response to a user hovering a mouse pointer over a highlighted user space, method 200 may provide detailed information about a user space update. Method 200 also comprises displaying a second user space including a second status representation in the user interface, as indicated in block 220.

Next, method 200 comprises changing the first status representation or the second status representation based on a change in status for the first user space or the second user space, as indicated at block 230. In some embodiments, a change in status may be a change in reputation. For example, in block 240 the method 200 may illustrate a change in reputation by further representing at least one of how many views a user space receives from other users, how often a user space is updated, how many comments a user space receives, or how long a user space has existed, as non-limiting examples. For example, a change in reputation may be represented by a change in size of an icon or other depiction of a user space, a change in location or a change in detail of an icon or other depiction of a user space, wherein the change in reputation is represented in the user interface.

In some embodiments, method 200 may further comprise displaying a plurality of other user spaces in the user interface, each of the plurality with a status representation, and changing the status representation of at least one of the first user space, the second user space, or the other user spaces.

In some embodiments, method 200 may further comprise tagging the first user space or the second user space with a tag, wherein the tag describes meta data associated with the first user space or the second user space. For example, a user may have a selection of tags wherein a user space to be tagged includes an illustration, is interactive, relates to magazines, has a motion component, provides music content, has a specific packaging, includes photography, etc., as non-limiting examples. When multiple user spaces within a user interface such as a themed place or location are tagged, then method 200 may further comprise filtering the user interface to display one or more user spaces having an associated tag. An example of filtering user spaces according to a music tag is described with reference to FIG. 6, below.

In some embodiments, method 200 may further comprise a customization tool menu, wherein a customization tool is an interactive icon that can be added to a user space within the user interface. As non-limiting examples, a customization tool menu may allow a user to edit a user space, add items to the user space such as music, news, packages, icons representing activities by the user, pictures, etc. In some embodiments, a customization tool may allow a user to change styles of their user space, for example by selecting between provided styles, naming a user space, adding items to a header of a user space, adding a menu of other selections to a user space, changing a background of a user space, randomly distributing items within a user space, saving or canceling style changes, etc.

FIG. 3 shows an example user interface 192 showing a place with a flower theme 300 including representations of multiple user spaces. In this example, each user's space appears as a flower in the flower theme 300. Additionally, multiple user spaces are depicted to show what is new, what is popular, a level of reputation, a degree of activity, etc., by providing flowers with different appearances.

For example, flowers may have a different appearance according to size, place, depth in the theme, detail, highlight, proximity to other flowers, etc. More complicated flowers and/or larger flowers may be used to represent greater activity, higher reputation, etc. In flower theme 300, flower 310 is large relative to flower 330 and is also displayed prominently in the foreground of the theme while flower 330 is displayed behind other flowers. In some embodiments, a Z-axis depth to a screen may be used to represent what is new, what is popular, a level of reputation, a degree of activity, etc. Additionally, flowers may be shown randomly by refreshing the theme or user interface, or user spaces can be filtered based on a search, etc. In some embodiments, user spaces may be filtered based upon user selected settings, such as preferred settings including showing most frequently contacted user spaces, showing only messenger favorite contacts, showing contacts according to some external service or filtering scheme, etc.

In some embodiments an update to a user space may be represented in a visually distinctive manner. Flower 320 is illustrated as surrounded with a dotted line representing a glowing highlight. In this example, a user may visually distinguish flower 320 from the other flowers and know that something significant has happened, such as an update to that user space.

FIG. 4 shows the example interface showing a flower theme 300 from FIG. 3 with a mouse hover over of a flower 320 with an update. By hovering a mouse over glowing flower 320, the user interface may display a graphical representation 420 such as a picture, icon, etc., with a preview of the updates 430 to the user space related to flower 320. In this example, the graphical representation 420 shows updates 430 related to music, a movie, and a posting. In an example embodiment, a user may click or select the music or movie updates 430 and be presented with a preview of new content in a pop-up window displaying more information about the new content, providing a link to the content, allowing the user to play the content, etc. Additionally, the graphical representation may show other content such as stars 440 to provide a more objective measure of reputation, a picture of the user (non shown), etc. In some embodiments, the graphical representation 420 may be made more visually distinctive by changing the rest of the flower theme 300, for example by making the other flowers in the theme softer, dimmer, out of focus, etc. Further, graphical representation 420 may provide information related to who last rated or commented on music, movies, a user space, or to who has rated multiples spaces, etc. We now refer to FIGS. 5-6 to describe an embodiment with a virtual earth theme.

FIG. 5 shows an example user interface 192 showing a virtual earth theme 500 for multiple user spaces according to the principles of this disclosure. This overview of spaces is similar as the flower theme, except users can place their space on a 3-dimensional representation of a map and an icon representing their space is customizable. Reputation, activity, status, etc., in virtual earth theme 500 may be shown by placement of an icon, graphical representation, etc. In one example, a new user space may be limited to placement at street level, on buildings, on certain buildings, etc.

In one example, reputation may be indicated by placing active or frequently visited user spaces with more reputation in the sky portion of virtual earth theme 500. In another example, reputation may be represented by icon size. For example, smiley face icon 560 may represent a user space that is frequently visited by other users while bicycle icon 530 may represent a new user space that has not been visited yet. In some embodiments, the graphical representation or icon may also change in relation to reputation, status, activity, etc. For example, a user space with a high reputation may include an animation or movie as opposed to a static picture or icon.

In some embodiments, user spaces may be overlaid on existing themes, graphics, etc., and toggled on or off. For example, the virtual earth theme 500 may be an actual image from a city, and user interface 192 may include a show space button. By clicking the show space button, the user spaces may be placed within the city image. When a user selects to show spaces, they can view all or a portion of the spaces that other users have placed within the city image. Additionally, icons may also illustrate other information, such as indicators of reputation similar to graphical representation 420 in flower theme 300, such as user name, the last activity or time by the user depicted by the user space, etc. In some embodiments, such as a 3-dimensional virtual earth theme 500, icons may be multiple sided with different information represented on different sides. Also, a user may be able to rotate or move a theme within an interface to provide a different view of the theme and represented user spaces.

In some embodiments, users can search user spaces in a theme to customize a view within user interface 192. For example, user spaces may be tagged by a user, automatically, by other users, etc., and a user may filter a view or theme based on these tags. In the present example, available tags for virtual earth theme 500 may be placed in a drop down search menu 550. In drop down search menu 550, one example tag is music. A user may access the drop down search menu 550, and can tag a user space as having music. In this way, a user may have a multitude of tags representing different information over a range of user space icons, and may filter a theme based on one or more of the tags. In the present example, a user may have tagged bicycle icon 530 and lightening icon 520 with a music tag. FIG. 6 shows a drop down search menu 550 and filtered user spaces after virtual earth theme 500 is filtered based upon music tags.

Similar to the flower theme 300, a user may then move their input device over a depicted icon and see more detailed information about the user space depicted by the icon. In this example, a user see songs that the music tagged lightening icon 520 user space has recently added, or has stored within a shared space, etc. Upon hovering over an icon, a user may see a user space name, reputation, a friends list, etc. If a user hovers over their own space they may be presented with an indication this it is their own space, options to move or resize their space, an option to update their space, an indication of recent messages or postings by other users, etc.

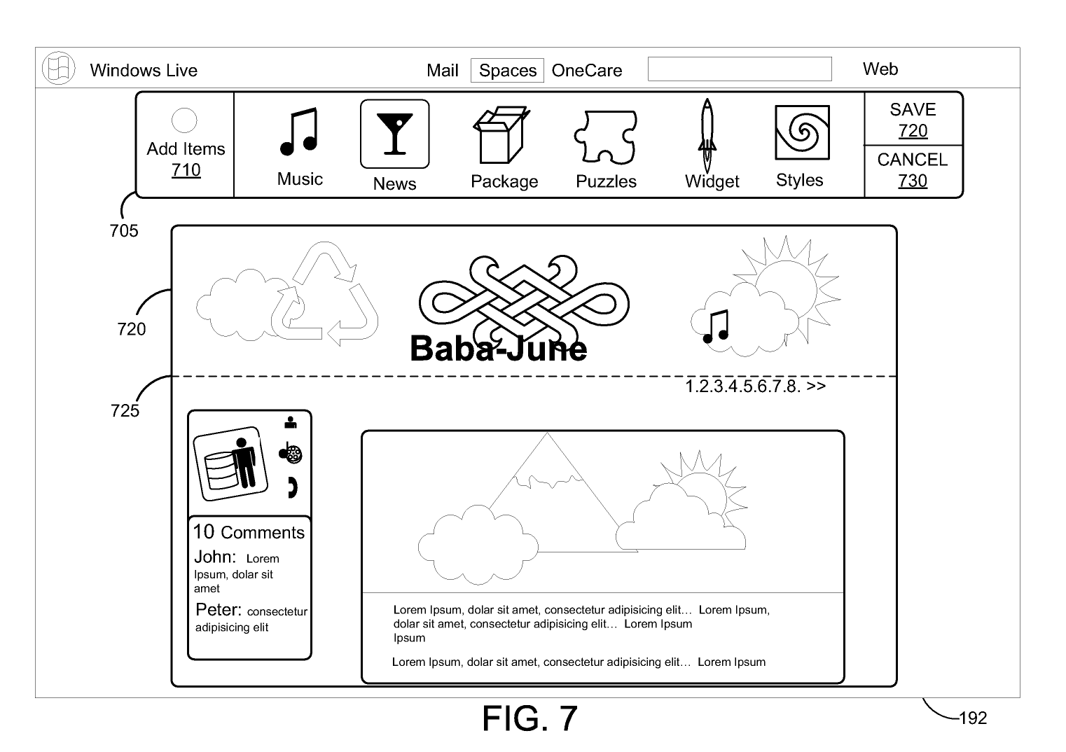

In some embodiments, a theme, place, or user interface may provide a customization tool. Referring to FIG. 7, a user may make their user space 720 more interesting or detailed based on available options in a customization tool drop down menu 705. For example, a user may change a style of their theme, place, space, etc., add an application/widget, add a music, etc. Additionally, tools in the drop down menu 705 may have additional functionality, for example, the music tool may open to show current music lists of a user, a favorite radio station, offer a shared listening experience, etc.

Although a user may optionally change their user space, the user space may also update based on reputation, status, activity, etc. Additionally, a drop down menu 705 allows a user to preview an item before actually adding it to their user space. Some embodiments may provide a randomize option to randomly change a user space or theme between styles, filters, etc. In this way, a user space can evolve based upon user selection or based upon user space activity, reputation, status, etc. In some cases, a user space may be adorned with additional decorations or applications based upon a user earning them through activity, postings, length of time in a theme, length of time of a user space, etc.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method for displaying multiple user spaces and corresponding status levels in a user interface, the method comprising:
displaying a first user space including a first status representation in a user interface;
displaying a second user space including a second status representation in the user interface; and
changing the first status representation or the second status representation based on a change in status for the first user space or the second user space.

2. The method of claim 1, wherein the second user space is one of a plurality of second user spaces, the method further comprising:
displaying a plurality of second user spaces in the user interface, each of the plurality with a status representation; and
changing a status representation of at least one of the first user space and the plurality of second user spaces.

3. The method of claim 1, wherein a change in status is a change in reputation, the change in reputation further including at least one of representing how many views a user space receives from other users, representing how often a user space is updated, representing how many comments a user space receives, or representing how long a user space has existed.

4. The method of claim 3, wherein a change in reputation is represented by a change in size, a change in location or a change in detail of the first user space or the second user space, wherein the change in reputation is represented in the user interface.

5. The method of claim 1, further comprising tagging the first user space or the second user space with a tag, wherein the tag describes meta data associated with the first user space or the second user space.

6. The method of claim 5, further comprising filtering the user interface to display one or more user spaces having an associated tag.

7. The method of claim 1, further comprising displaying an update to the first user space or the second user space, wherein displaying an update includes highlighting the first user space or the second user space.

8. The method of claim 7, further comprising:
hovering a mouse pointer over a highlighted user space; and
displaying detailed information about an update to the highlighted user space.

9. The method of claim 1, further comprising a customization tool menu, wherein a customization tool is an interactive icon that can be added to a user space within the user interface.

10. A computer-readable medium comprising instructions executable by a computing device to display multiple user spaces and corresponding status levels in a user interface, the instructions being executable to perform a method comprising:
displaying a first user space including a first status representation in a user interface;
displaying a second user space including a second status representation in the user interface; and
changing the first status representation or the second status representation based on a change in status for the first user space or the second user space.

11. The computer-readable medium of claim 10, wherein the second user space is one of a plurality of second user spaces, the computer-readable medium further comprising instructions for:
displaying a plurality of second user spaces in the user interface, each of the plurality with a status representation; and
changing a status representation of at least one of the first user space and the plurality of second user spaces.

12. The computer-readable medium of claim 10, wherein a change in status is a change in reputation, the computer-readable medium further including instructions for at least one of representing how many views a user space receives from other users, representing how often a user space is updated, representing how many comments a user space receives, or representing how long a user space has existed.

13. The computer-readable medium of claim 12, wherein a change in reputation is represented by a change in size, a change in location or a change in detail of the first user space or the second user space, wherein the change in reputation is represented in the user interface.

14. The computer-readable medium of claim 10, further comprising instructions for tagging the first user space or the second user space with a tag, wherein the tag describes meta data associated with the first user space or the second user space.

15. The computer-readable medium of claim 14, further comprising instructions for filtering the user interface to display one or more user spaces having an associated tag.

16. The computer-readable medium of claim 10, further comprising instructions for displaying an update to the first user space or the second user space, wherein displaying an update includes highlighting the first user space or the second user space.

17. The computer-readable medium of claim 16, further comprising instructions for displaying detailed information about an update to a highlighted user space in response to a mouse pointer hovering over the highlighted user space.

18. The computer-readable medium of claim 10, further comprising a customization tool menu, wherein a customization tool is an interactive icon that can be added to a user space within the user interface.

19. A system for displaying multiple user spaces and corresponding status levels in a user interface, the system with an input, a memory, and a processor in communication with the input and the memory, the system comprising:
a user space module configured to receive an input related to a first user space and to update a status of the first user space;
an interface module configured to generate a first status representation related to the first user space and a second status representation related to a second user space; and
a user interface configured to:
display the first status representation;
display the second status representation; and
change the first status representation based on the input related to the first user space when the status for the first user space is updated.

20. The apparatus of claim 19, wherein a change in status is a change in reputation, the change in reputation further including a representation of at least one of how many views a user space receives from other users, how often a user space is updated, how many comments a user space receives, or how long a user space has existed.
